(19) United States
(12) Patent Application Publication
(10) Pub. No.: US 2025/0272902 A1
(43) Pub. Date: Aug. 28, 2025

(54) ADAPTIVE ORIENTATION CONTROL FOR INTERACTIVE ARTIFICIAL INTELLIGENCE SYSTEMS

(71) Applicant: DOPPLE WORKS, INC., Catskill, NY (US)

(72) Inventors: Gregory FODOR, JR., Campbell, CA (US); Robert KALIN, Catskill, NY (US); Geoffrey W. CHATTERTON, Southport, ME (US)

(21) Appl. No.: 19/066,947

(22) Filed: Feb. 28, 2025

Related U.S. Application Data
(60) Provisional application No. 63/559,099, filed on Feb. 28, 2024.

(51) Int. Cl. G06T 13/20; G06F 3/01; G06T 13/40; G10L 15/22

(52) U.S. Cl. CPC G06T 13/205; G06F 3/013; G06T 13/40; G10L 15/22; G10L 2015/223

(57) ABSTRACT

A system may include a sensor, a display, and a processor. The sensor may generate sensor data based on a factor of the system. The display may display an animated face of an artificial intelligence (AI) agent. The processor may be coupled to the sensor and the display. The processor may determine an orientation of the system based on the sensor data. The processor may also determine an orientation of a face of a user relative to the system based on the sensor data. IN addition, the processor may control rotation of the animated face on the display based on the orientation of the system and the orientation of the face of the user to maintain a consistent orientation of the animated face on the display relative to the face of the user.

### CROSS REFERENCE TO RELATED APPLICATION

This patent application claims the benefit of and priority to U.S. Provisional Application No. 63/559,099 filed Feb. 28, 2024, titled “INTERACTIVE ARTIFICIAL INTELLIGENCE SYSTEM,” which is incorporated herein by specific reference in its entirety.

### FIELD

The embodiments discussed in the present disclosure are related to adaptive orientation control for interactive artificial intelligence systems.

### BACKGROUND

Unless otherwise indicated in the present disclosure, the materials described in the present disclosure are not prior art to the claims in the present application and are not admitted to be prior art by inclusion in this section.

An artificial intelligence (AI) system may be utilized in various applications to engage a user via interactions with an AI agent of the AI system. Examples of the AI agent include, but are not limited to, a virtual assistant, a chatbot, or other types of AI agents. The user may interact with the AI agent using different formats such as a text-based format, an audio-based format, an image-based format, or any other appropriate format or combination of formats. For example, the AI system may include natural language processing or speech recognition to process, understand, and respond to voice commands (e.g., audio-based format) or written commands (e.g., text-based format). Such processes allow the AI system to interact with the user via the AI agent more naturally.

The AI agent may be displayed as a visual representation on a display to create a more engaging and natural interaction experience for the user. For example, the AI agent may be displayed as an animated entity or part of an animated entity. However, some AI systems may display the AI agent in ways that hinder a natural feeling interaction. For example, these AI systems may constrain how the AI agent is visually represented or positioned such that the user may be unable to maintain consistent visual engagement with the AI agent (e.g., the visual representation of the AI agent).

Some AI systems may be hard for certain users to use. For example, some AI systems may be difficult for children to use because children may not be able to provide input as text and/or children may not be able to naturally engage with these AI systems using voice commands.

The subject matter claimed in the present disclosure is not limited to embodiments that solve any disadvantages or that operate only in environments such as those described above. Rather, this background is only provided to illustrate one example technology area where some embodiments described in the present disclosure may be practiced.

### SUMMARY

This Summary is provided to introduce a selection of concepts in a simplified form that are further described below in the Detailed Description. This Summary is not intended to identify key features or essential characteristics of the claimed subject matter, nor is it intended to be used as an aid in determining the scope of the claimed subject matter.

A system may include a sensor, a display, and a processor. The sensor may generate sensor data based on a factor of the system. The display may display an animated face of an artificial intelligence (AI) agent. The processor may be coupled to the sensor and the display. The processor may determine an orientation of the system based on the sensor data. The processor may also determine an orientation of a face of a user relative to the system based on the sensor data. In addition, the processor may control rotation of the animated face on the display based on the orientation of the system and the orientation of the face of the user to maintain a consistent orientation of the animated face on the display relative to the face of the user.

A system may include a sensor, a display, a housing, and a processor. The sensor may generate sensor data based on a factor of the system. The display may display an animated face of an AI agent such that the animated face occupies an entirety of a viewable area of the display. The animated face may include a facial feature. The housing may house the display. The housing may define the viewable area of the display. The processor may be coupled to the sensor and the display. The processor may determine an orientation of the system based on the sensor data. The processor may also determine an orientation of a face of a user relative to the system based on the sensor data. In addition, the processor may position the animated face on the display based on the orientation of the system and the orientation of the face of the user to maintain a consistent orientation of the animated face on the display relative to the face of the user. Further, the processor may identify an output of the system. The processor may animate the facial feature of the animated face based on the identified output of the system such that the facial feature is synchronized with the output of the system.

The object and advantages of the embodiments will be realized and achieved at least by the elements, features, and combinations particularly pointed out in the claims. Both the foregoing general description and the following detailed description are exemplary and explanatory and are not restrictive.

### BRIEF DESCRIPTION OF THE DRAWINGS

Example embodiments will be described and explained with additional specificity and detail through the use of the accompanying drawings in which:

FIG. 1 illustrates an example environment in which an interactive AI system may be implemented;

FIGS. 2A and 2B illustrate a front perspective view and a rear perspective view of an example of the interactive AI system of FIG. 1;

FIGS. 3A and 3B illustrate an example user interacting with the example interactive AI system of FIGS. 2A and 2B in different orientations;

FIG. 4 illustrates a front perspective view of another example of the interactive AI system of FIG. 1;

FIGS. 5A and 5B illustrate an example user interacting with the example interactive AI system of FIG. 4 in different orientations;

FIG. 6 illustrates a block diagram of an example computing device that may be implemented in the environment of FIG. 1,

all according to at least one embodiment described in the present disclosure.

### DETAILED DESCRIPTION

An AI system may generate output based on input received from the user (referred to generally herein as “user input”), local data (e.g., data stored on the AI system), remote data (e.g., data stored remote from the AI system), or some combination thereof. For example, the user input may include a question, and the AI system may process the user input based on the local data or the remote data to determine and provide, via the AI agent, answers to the question.

In some embodiments, the user input may include additional data (e.g., additional context) and/or specific settings for the AI system. For example, the user input may indicate that a question involves a specific subject and that the AI system is to limit the answer to that specific subject. The AI system may process the additional data or the specific settings along with the local data and/or the remote data to refine the output. For example, the AI system may process the additional data, the specific settings, the local data, or the remote data to limit the answer to the question to the specific subject. Accordingly, the AI system may provide a user with means to interact with data and/or the AI agent of the AI system.

However, some AI systems may lack social presence (e.g., the AI agent is not able to maintain engagement with the user) such that the user does not interact naturally with the AI agent. For example, some AI systems may display the AI agent as a simple icon or as a disembodied being (e.g., a being that is embedded within a digital border), which does not create an intuitive and natural interface. As another example, some AI systems may display the AI agent using a display that breaks an illusion of face-to-face communication due to a shape of the display or an orientation of the AI agent on the display relative to the system. In other words, some AI systems may not create the feeling that the user is speaking directly with the AI agent face-to-face in unmediated communication.

There are opportunities to improve how the AI agent is displayed to create an intuitive and natural interface for the user, which may increase user engagement and overall utility of the AI system.

The present disclosure provides an AI system that creates an intuitive and natural interface between the user and the AI system. The AI system of the present disclosure enables natural interactions between the AI system and the user. Additionally, the AI system displays the AI agent in a manner that causes the AI agent to form part of a computing device that is implementing the AI system and not merely as a disembodied being.

The AI system may display the AI agent as an animated face on a surface of the device via a display. In some embodiments, the display may include a shape that is the same or similar to a shape of the face of the AI agent to make the face of the AI agent appear as if to form part of the computing device. Additionally, as the AI system (e.g., the computing device) is rotated, the AI system may rotate the AI agent on the display to maintain orientation of the animated face of the AI agent relative to eyes of the user rather than an orientation of the AI system.

The AI system may include a sensor, a display, or a processor. The sensor may generate sensor data based on a factor of the system (e.g., based on movement or a location of the AI system). The display may display an animated face of the AI agent such that the AI agent forms part of the computing device implementing the AI system. The processor may determine an orientation of the AI system (e.g., the computing device) based on the sensor data. In addition, the processor may determine an orientation of a face of the user relative to the AI system (e.g., relative to the display) based on the sensor data. Further, the processor may control rotation of the animated face on the display based on the orientation of the AI system, the orientation of the face of the user, or both. Additionally, the processor may control the rotation of the animated face to maintain a consistent orientation of the animated face of the AI agent relative to the face of the user.

The AI system may include a housing that permits the user to hold the AI system at a variety of angles or orientations. In addition, the processor may control rotation of the animated face to maintain a consistent orientation relative to the user to permit the user to hold (e.g., position) the housing and/or any part of the AI system based on a preference of the user rather than constraints of the AI system. For example, the user may hold a handle and/or an upper body of the AI system in their hands in a preferred (e.g., comfortable or convenient) position rather than keep the AI system in a particular orientation.

Additionally or alternatively, the AI system may include an input device (e.g., a camera) configured to capture input data. For example, the camera may capture image data representative of a scene. The processor may control orientation of the input data based on the orientation of the user, the direction of gravity, or both. In particular, the processor may permit the orientation of the input data to be based on the orientation of the user, the direction of gravity, or both rather than the orientation of the input data being fixed relative to the input device or the AI system. For example, the processor may cause an orientation of a view of the camera to be based on the orientation of the user, the direction of gravity, or both rather than the orientation of the view being fixed relative to the camera or the AI system. As another example, the processor may process the image data to reorient the image data relative to the orientation of the user, the direction of gravity, or both.

The AI system described in the present disclosure may permit the user to naturally interact with the AI agent while the user holds the computing device implementing the AI system at a variety of angles or orientations compared to an AI system that displays the AI agent in a fixed orientation. Further, the AI system described in the present disclosure displays the AI agent in a manner that fuses or embeds the animated face of the AI agent in the computing device implementing the AI system such that the AI agent appears as a face of the computing device. Therefore, the AI agent includes a social presence that creates a feeling of face-to-face communication between the user and the AI system (e.g., the computing device) rather than causing the user to feel like they are interacting with a disembodied being.

The AI system described in the present disclosure permits the user to hold the AI system based on the preference of the user and to capture input data based on the orientation of the user, the direction of gravity, or both. For example, the AI system may permit the user to capture a selfie using the camera and the selfie can be oriented based on the orientation of the user, the direction of gravity, or both rather than the orientation of the AI system.

These and other embodiments of the present disclosure will be explained with reference to the accompanying figures. It is to be understood that the figures are diagrammatic and schematic representations of such example embodiments, and are not limiting, nor are they necessarily drawn to scale. In the figures, features with like numbers indicate like structure and function unless described otherwise.

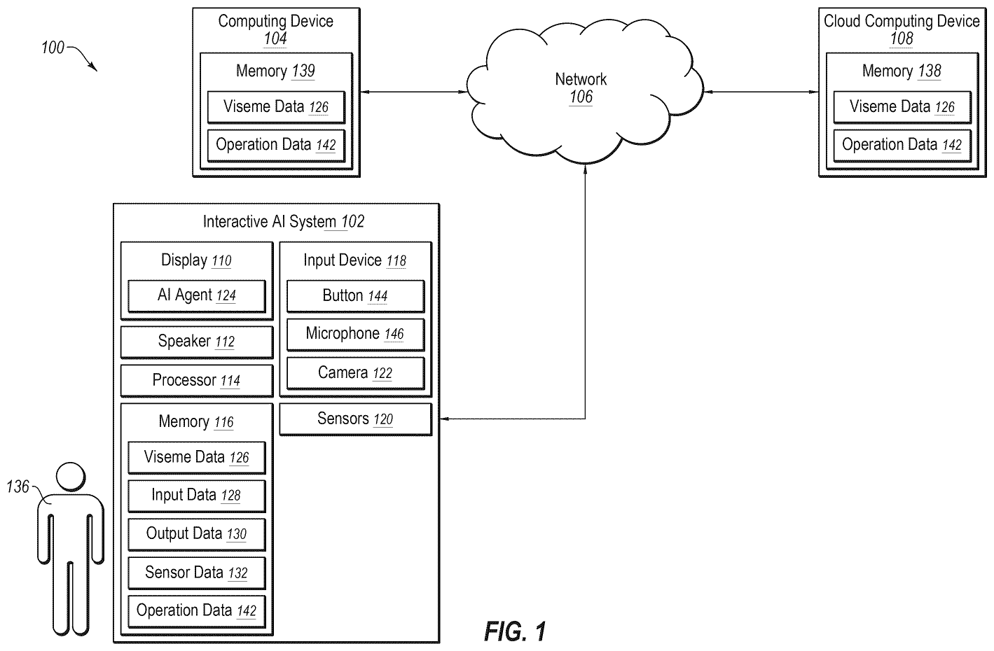

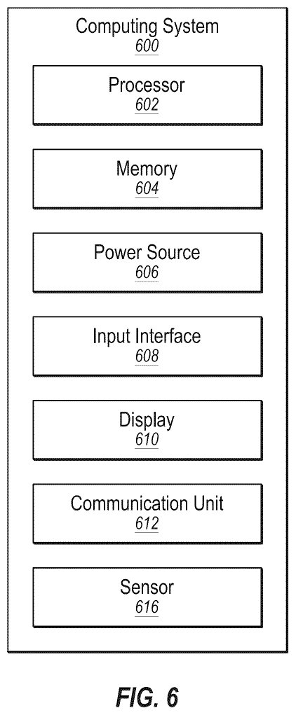

FIG. 1 illustrates an example environment 100 in which an interactive AI system 102 may be implemented, in accordance with one or more embodiments of the present disclosure. The environment 100 may include the interactive AI system 102, a computing device 104, a network 106, and/or a cloud computing device 108. The interactive AI system 102 may include or be implemented on a computing device, an example of which is shown and described below in relation to FIG. 6.

The interactive AI system 102 (referred to herein as the AI system 102) may include a display 110 configured to display an AI agent 124. The AI system 102 may also include a speaker 112, a processor 114, a memory 116, an input device 118, or one or more sensors 120. The processor 114 may be coupled to the display 110, the speaker 112, the memory 116, the input device 118, or the sensors 120.

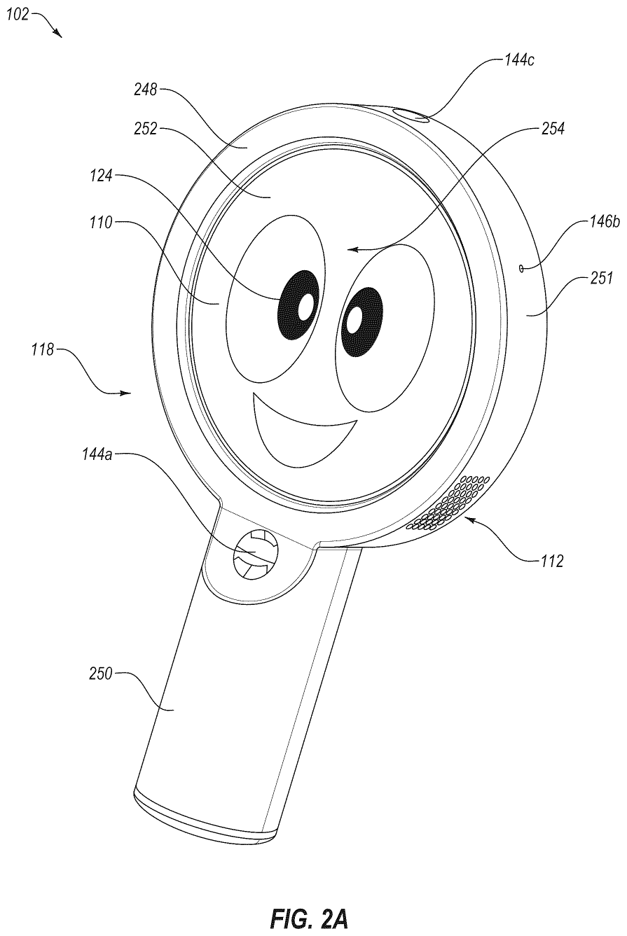

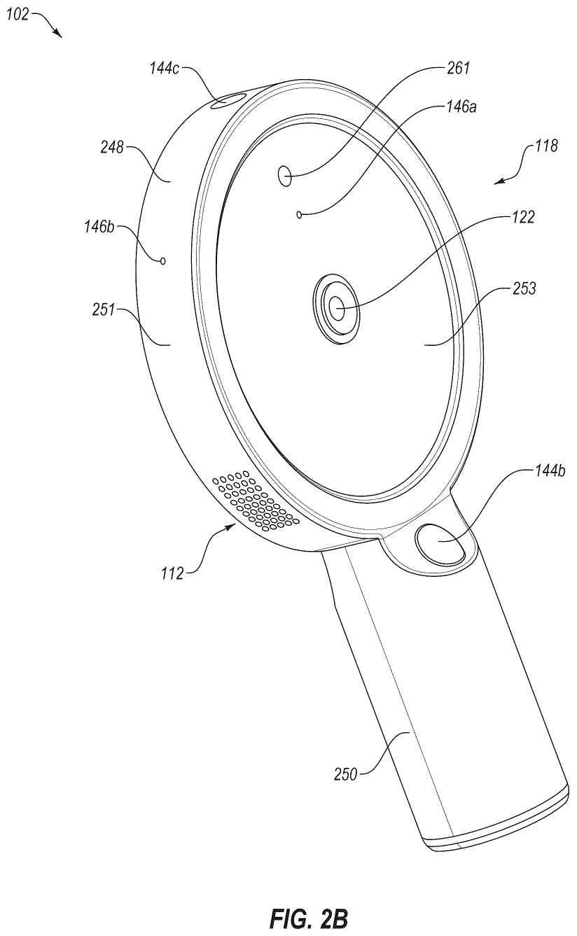

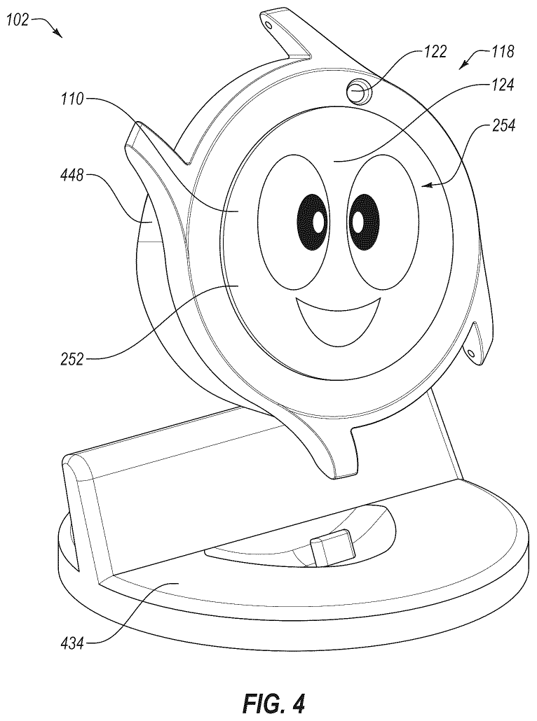

The AI system 102 may permit a user 136 to interact with AI or the AI agent 124 in a manner that creates the illusion of face-to-face communication between the user 136 and the AI system 102. For example, the AI system 102 may include a hand-held device that permits the user 136 to provide user input to the AI system 102 in a user-friendly way. Examples of hand-held versions of the AI system 102 are shown and described in more detail below in relation to FIGS. 2A, 2B, and 4. The AI agent 124 may be displayed so as to create an illusion that the user 136 is interacting with the AI system 102 directly as a specific entity rather than merely a machine or a disembodied being. Further, the AI system 102 may generate output based on the user input and animate the AI agent 124 such that the AI agent 124 is synchronized and appears to be speaking the output.

The user 136 may interact with the AI agent 124 or the AI system 102 via the input device 118. Additionally or alternatively, the user 136 may interact with the AI agent 124 via the display 110. Interacting with the AI agent 124 of the present disclosure may include interacting with the visual representation of the AI agent 124 (e.g., the animated face), the input device 118, or any other appropriate aspect of the AI system 102.

The user 136 may provide the user input to control the AI system 102 or interact with the AI agent 124. For example, the user 136 may press and hold a button 144 of the input device 118 while speaking to provide the user input as a voice input. As another example, the user 136 may release the button 144 to signal the end of the user input. As another example, the button 144 may mute/unmute the AI system 102, adjust a volume of the AI system 102, or activate different modes of operation of the AI system 102.

In some embodiments, the input device 118 may capture the user input and generate input data 128 representative of the user input. For example, the input device 118 may receive the user input as voice commands via a microphone 146 and the microphone 146 may generate the input data 128 as a waveform representative of the voice commands. In these and other embodiments, the input device 118 may capture the user input and the processor 114 may generate the input data 128 representative of the user input. For example, the input device 118 may receive the user input as touch commands via the display 110 and/or the button 144 and the processor 114 may generate the input data 128 accordingly. In some embodiments, the button 144 may include a capacitance device configured to detect a touch of the user 136.

The input device 118 may include a camera 122 that captures image data representative of the user 136 or of the environment 100 (e.g., a scene) within a view of the camera 122. In addition, the input data 128 may include the image data. In some embodiments, the user 136 may direct the camera 122 at a document, a picture, or any other appropriate object to permit the camera 122 to capture the image data representative of the object. For example, the user 136 may direct the camera 122 at a page of a book and the input data 128 may be representative of words on the page. As another example, the user 136 may direct the camera 122 at a picture within the environment 100 and the input data 128 may be representative of the picture.

In some embodiments, the camera 122 may capture the image data with an orientation that is based on the orientation of the user 136, a direction of gravity, or both. For example, the camera 122 may receive instructions from the processor 114 indicating an orientation at which the camera 122 is to capture the image data (e.g., the instructions may indicate the orientation of the user 136, the direction of gravity, or both). As another example, the camera 122 may include a sensor (not shown) configured to detect the direction of gravity.

In some embodiments, the processor 114 may control an orientation of a view of the camera 122 based on the orientation of the user 136, the direction of gravity, or both. In other embodiments, the camera 122 may capture the image data based on a fixed orientation of the view of the camera 122 and the processor 114 may process the image data to reorient it based on the orientation of the user 136, the direction of gravity, or both.

The microphone 146 may capture the voice commands spoken by the user 136 or sounds in the environment 100. Additionally, the input data 128 may include audio data representative of the voice commands or the sounds in the environment 100. In some embodiments, the user 136 may speak one or more phrases which are captured by the microphone 146 as the audio data. In some embodiments, the microphone 146 or the processor 114 may generate the input data 128 based on the audio data. For example, the user 136 may speak a voice command to search through a particular database, perform a calculation, set a reminder, or any other appropriate command and the processor 114 may generate the input data 128 representative of the command.

In some embodiments, the user input received via different devices may be combined in the input data 128. For example, the user 136 may direct the camera 122 at an object and speak about what the camera 122 is directed at and the processor 114 may associate the image data and the audio data in the input data 128.

The display 110 may include a touch sensitive surface configured to capture touch input from the user 136 and the input device 118 may generate the input data 128 based on the touch input. For example, the user 136 may touch a portion of the display 110 to move the AI agent 124.

The processor 114 may cause the display 110 to display the AI agent 124 as an animated face. In other words, the display 110 may display the animated face of the AI agent 124. The AI agent 124 (e.g., the animated face) may include facial features. For example, the AI agent 124 may include a nose, a skin tone, hair, facial hair, a mouth, eyes, eyebrows, a forehead, a chin, cheeks, or any other appropriate facial feature. In some embodiments, the AI agent 124 may include different accessories such as earrings, makeup, or other appropriate accessories.

In some embodiments, the processor 114 may cause the AI agent 124 to be displayed to represent a human. In other embodiments, the processor 114 may cause the AI agent 124 to be displayed to represent a non-human such as an animal (e.g., a dog, a cat, or a bear) or a fantasy creature (e.g., a dragon, an elf, or an angel).

In some embodiments, the AI agent 124 may be displayed such that the animated face occupies an entirety of a viewable area of the display 110. Accordingly, the AI agent 124 may cause the display 110 to appear as the face of the AI system 102 rather than the AI agent 124 appearing to merely be an avatar within a screen or an icon on a display. The viewable area of the display 110 is discussed in more detail below in relation to FIGS. 2A, 2B, and 4.

The processor 114 may animate the AI agent 124 to indicate information to the user 136. For example, the processor 114 may animate the AI agent 124 such that eyes of the AI agent 124 blink or look around the environment 100 to indicate that the AI agent 124 is active and ready to interact with the user 136. As another example, the processor 114 may cause the eyes of the AI agent 124 to glance in directions to indicate to the user 136 that the AI system 102 detected something of interest in those directions. As another example, the processor 114 may animate the AI agent 124 such that the eyes of the AI agent 124 follow eyes of the user 136 to maintain eye contact as described in more detail below.

In some embodiments, the AI system 102 may receive viseme data 126, operation data 142, or any other appropriate data from the computing device 104 or the cloud computing device 108. For example, the computing device 104 may be located proximate to the AI system 102 and the AI system 102 may receive the viseme data 126 or the operation data 142 via a wired connection. As another example, the AI system 102 may receive the viseme data 126 or the operation data 142 from the cloud computing device 108 either directly via the network 106 or indirectly via the network 106 and a wired connection to the computing device 104.

The operation data 142 may include any appropriate information to allow the AI system 102 to perform operations described in the present disclosure. For example, the operation data 142 may include data configured to permit the AI system 102 to perform object detection, process information, identify content of user input, generate output, or any other appropriate function. As another example, the operation data 142 may permit the AI system 102 to operate as if including an AI model or other processing model.

The memory 116 may store the viseme data 126, the input data 128, output data 130, sensor data 132, or the operation data 142 for use by the AI system 102 (e.g., the processor 114). The viseme data 126 may represent visual positions and movements of facial features corresponding to different speech sounds or various words. The output data 130 may represent the output that is generated by the AI system 102. In some embodiments, the output data 130 may represent audio samples, phonemes, words, phrases, and other speech-related information used for speech synthesis. In these and other embodiments, the output data 130 may permit the AI system 102 to provide natural-sounding speech output for the AI agent 124 via the speaker 112 or any other appropriate type of output.

The processor 114 may generate the output data 130 based on the input data 128, the sensor data 132, the viseme data 126, the operation data 142, or any other appropriate data stored in the memory 116. Alternatively, the processor 114 may generate the output data 130 based on the viseme data 126, the operation data 142, input data 128, the sensor data 132, the viseme data 126, the operation data 142, or any other appropriate data stored in a memory 139 of the computing device 104 or a memory 138 of the cloud computing device 108.

The processor 114 may cause the output to be provided to the user 136 as audio output via the speaker 112, as haptic output via a housing, as visual output via the display 110, or via any other appropriate method. Additionally, the processor 114 may animate the AI agent 124 to be synchronized with the output. For example, the processor 114 may animate the facial features of the AI agent 124 to correspond to the audio output of the AI system 102 to make the AI agent 124 appear as if it is speaking the audio output.

In some embodiments, the processor 114 may identify words that form at least part of the output and use the viseme data 126 to animate the AI agent 124 in synchronization with the words generated using the speaker 112. For example, the output data 130 may include an audio waveform and the processor 114 may estimate poses for the facial features of the AI agent 124 using the viseme data 126 to correspond to the audio waveform when played on the speaker 112. In some embodiments, the processor 114 may implement a neural network to estimate the poses of the facial features of the AI agent 124. In these and other embodiments, the processor 114 may estimate the poses as control point settings, vertex morphs, or any other appropriate method to describe poses when animating a digital character.

The sensors 120 (generally referred to in the present disclosure as the sensor 120) may generate the sensor data 132 based on factors of the AI system 102. The sensor data 132 may be representative of the factors of the AI system 102. For example, the sensor data 132 may be representative of the orientation, a location, or movement of the AI system 102. The sensor 120 may include an accelerometer, an inertial measurement unit (IMU), a magnetometer, a gyroscope, a magnetic compass, or a light detection and ranging sensor. The sensor 120 may measure and/or report acceleration, orientation, angular rates, and other gravitational forces of the AI system 102. In some embodiments, the sensor 120 may include a camera (e.g., the camera 122) configured to capture image data representative of a location or orientation of a face, facial features, or other parts of the face (e.g., eyes) of the user 136.

The processor 114 may determine an orientation of the AI system 102 or the display 110 based on the sensor data 132. For example, the processor 114 may process the sensor data 132 to determine the orientation of the AI system 102. Additionally or alternatively, the processor 114 may determine an orientation of the face of the user 136 (e.g., eyes of the user 136) relative to the AI system 102 (e.g., the display 110) based on the sensor data 132. For example, the processor 114 may perform object detection in images captured by the camera of the sensor 120 to locate the eyes of the user 136. As another example, the sensor data 132 may include LiDAR data and the processor 114 may process the LiDAR data to determine a location of facial features including the eyes of the user 136.

The processor 114 may control rotation of the AI agent 124 within the display 110 based on the orientation of the system, the orientation of the face of the user 136, or both. In particular, the processor 114 may orient the animated face of the AI agent 124 on the display 110 to maintain a consistent orientation of the animated face of the AI agent 124 relative to the user 136. For instance, the processor 114 may orient the animated face of the AI agent 124 on the display 110 to maintain eye contact between the AI agent 124 and the user 136 regardless of the orientation of the AI system 102.

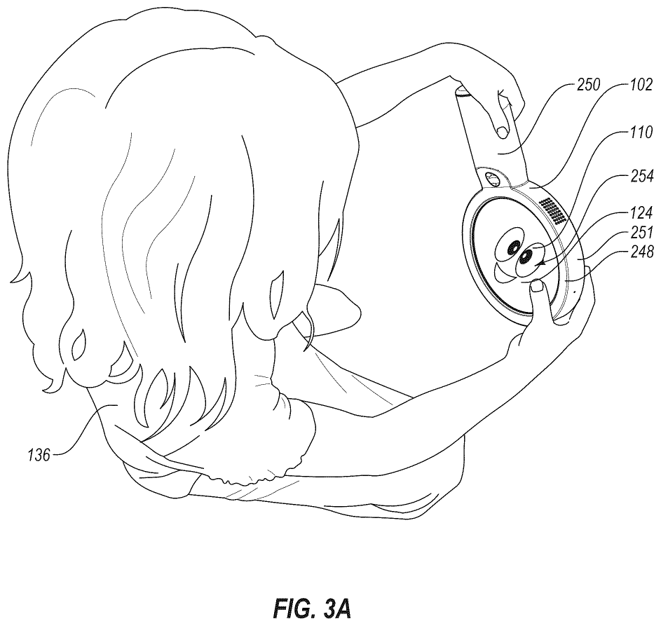

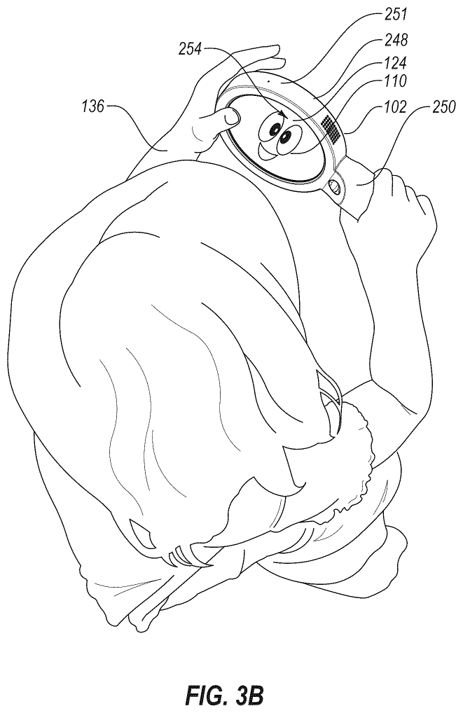

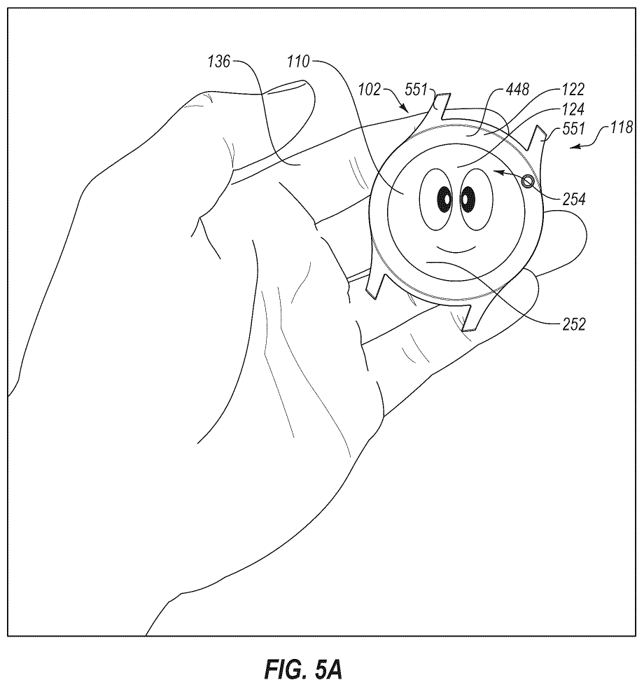

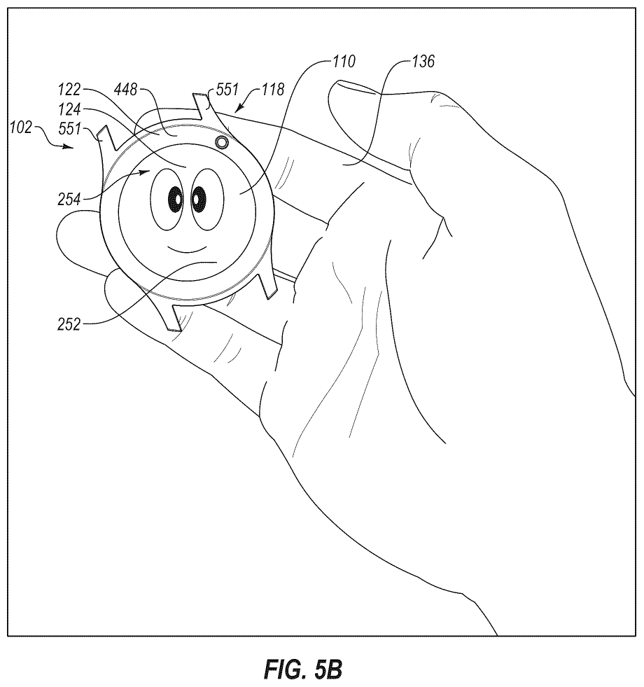

In some embodiments, the processor 114 may control the rotation of the AI agent 124 on the display 110 to maintain a consistent orientation of the animated face (e.g., the facial features) on the display 110 with respect to the face of the user 136. In other words, the processor 114 may control the rotation of the AI agent 124 on the display 110 such that the orientation of the AI agent 124 is aligned with the orientation of the face of the user 136 regardless of the orientation, movement, or both of the AI system 102. Examples of the orientation of the AI agent being aligned with the orientation of the face of the user 136 are shown and described in more detail below in relation to FIGS. 3A, 3B, 5A, and 5B.

The processor 114 may control the rotation of the animated face of the AI agent 124 on the display 110 to permit the user 136 to position the AI system 102 in different positions (e.g., different desired positions) or orientations based on a preference of the user 136 rather than factors of the display 110 or the AI system 102 (e.g., based on the desired positions rather than a constraint of the AI system 102).

The processor 114 may control placement or angles of the facial features of the AI agent 124 to maintain the eye contact between the user 136 and the AI agent 124. The processor 114 may track movement of the eyes of the user 136 based on the image data captured by the camera of the sensor 120 (e.g., perform face tracking using image data captured by a front facing camera (not shown)). Additionally, the processor 114 may control a gaze of the eyes of the AI agent 124 based on the movement of the eyes of the user 136. For example, if the user 136 looks to their left, the processor 114 may animate the eyes of the AI agent 124 to also look to the left of the user 136.

Alternatively, the processor 114 may control the placement or angles of the eyes of the AI agent 124 to cause the AI agent 124 to appear to be looking at an object the user 136 is looking at. For example, the eyes of the user 136 may move up to look at a ceiling and the processor 114 may cause the eyes of the AI agent 124 to also look up at the ceiling.

The processor 114 may animate the AI agent 124 based on operations performed by the AI system 102. For example, the processor 114 may cause a mouth of the AI agent 124 to disappear to indicate that the AI system 102 has been muted. As another example, the processor 114 may cause the eyes of the AI agent 124 to close to indicate that the AI system 102 is in a sleep mode. As yet another example, the processor 114 may cause the eyes of the AI agent 124 to wink to indicate that the AI agent 124 has a secret to communicate to the user 136.

The processor 114, when the user 136 is providing the user input, may animate the AI agent 124 to show that the user 136 has the attention of the AI agent 124. Additionally or alternatively, the processor 114 may cause the AI agent 124 to move to create the illusion that the AI agent 124 is thinking while performing calculations or searching databases.

The processor 114 may cause the AI system 102 to transition between modes based on the user input. In some embodiments, the AI system 102 may operate in a sleep mode or an active mode. In the sleep mode, the display 110 may be turned off or in a standby mode. In addition, in the sleep mode, the microphone 146 may capture audio input and the processor 114 may determine if the audio input includes a wake command or a wake word. For example, the processor 114 may determine if the audio input includes a name of the AI system 102 or a greeting for the AI system 102.

If the audio input includes a wake command or a wake word, the processor 114 may cause the display 110 to transition from the off or standby mode to the active mode. In addition, the processor 114 may cause the animated face of the AI agent 124 to be displayed on the display 110. In some embodiments, the wake command may be predetermined. In other embodiments, the wake command may be determined and/or set by the user 136.

The processor 114 may cause the AI system 102 to transition from the sleep mode to the active mode based on the user input received via the button 144 or the display 110. For example, the user 136 may press the button 144 or touch the display 110 to cause the AI agent 124 to wake up (e.g., cause the AI system 102 to transition to the active mode) and begin a conversation with the user 136.

In some embodiments, the processor 114 may animate the facial features of the AI agent 124 such that the AI agent 124 appears to show or create an illusion of having different emotions. For example, the one or more facial features of the AI agent 124 may be animated to show happiness (e.g., a happy face), sadness (e.g., a sad face), excitement (e.g., an excited face), or any other appropriate emotion or face.

In some embodiments, the processor 114 may determine an emotion corresponding to the output of the AI system 102. In these and other embodiments, the processor 114 may animate the AI agent 124 to show the emotion corresponding to the output of the AI system 102. For example, the processor 114 may determine the user 136 is happy by processing image data representative of the user 136 and the processor 114 may animate the AI agent 124 to reflect happiness.

In some embodiments, the processor 114 may animate the AI agent 124 to appear to react to the user 136 touching the display 110. For example, when the user 136 touches a certain part of the display 110, the processor 114 may animate the AI agent 124 as if reacting to the touch.

In some embodiments, the processor 114 may be configured to cause the display 110 to display the AI agent 124 with different faces or facial features. In these and other embodiments, the different faces or facial features may be displayed based on different functions and/or operations being performed by the AI system 102. For example, the processor 114 may cause different faces to be displayed for different applications being run by the AI system 102. Additionally or alternatively, the processor 114 may cause different faces or facial features to be displayed based on an identity of the user 136. In other words, the processor 114 may cause different faces or facial features to be displayed for different users. In some embodiments, the user 136 may select the face or facial features of the AI agent 124 that are displayed.

In some embodiments, the AI system 102 may be associated with a dock (not shown). In some embodiments, the dock may receive the AI system 102 to stabilize, charge, or secure the AI system 102. For example, the AI system 102 may include a power source (not shown) such as a rechargeable battery and the dock may charge the power source.

The network 106 may include any communication network configured for communication of signals between any of the components (e.g., 102, 104, or 108) of the environment 100. The network 106 may be wired or wireless. The network 106 may have numerous configurations including a star configuration, a token ring configuration, or another suitable configuration. Furthermore, the network 106 may include a local area network (LAN), a wide area network (WAN) (e.g., the Internet), and/or other interconnected data paths across which multiple devices may communicate. In some embodiments, the network 106 may include a peer-to-peer network. The network 106 may also be coupled to or include portions of a telecommunications network that may enable communication of data in a variety of different communication protocols.

In some embodiments, the network 106 includes or is configured to include a BLUETOOTH® communication network, a Z-Wave® communication network, an Insteon® communication network, an EnOcean® communication network, a wireless fidelity (Wi-Fi) communication network, a ZigBee communication network, a HomePlug communication network, a Power-line Communication (PLC) communication network, a message queue telemetry transport (MQTT) communication network, a MQTT-sensor (MQTT-S) communication network, a constrained application protocol (CoAP) communication network, a representative state transfer application protocol interface (REST API) communication network, an extensible messaging and presence protocol (XMPP) communication network, a cellular communications network, any similar communication networks, or any combination thereof for sending and receiving data. The data communicated in the network 106 may include data communicated via short messaging service (SMS), multimedia messaging service (MMS), hypertext transfer protocol (HTTP), direct data connection, wireless application protocol (WAP), e-mail, smart energy profile (SEP), ECHONET Lite, OpenADR, or any other protocol that may be implemented with the AI system 102, the computing device 104, or the cloud computing device 108.

The processor 114 may include a central processing unit (CPU), a microprocessor (μP), a microcontroller (μC), a digital signal processor (DSP), a field-programmable gate array (FPGA), an application-specific integrated circuit (ASIC), or any combination thereof. The processor 114 may be configured to execute computer instructions that, when executed, cause the processor 114 or the AI system 102, to perform or control performance of one or more of the operations described herein with respect to operation of the AI system 102. The processor 114 may be implemented using a combination of hardware and software. In the present disclosure, operations described as being performed by the processor 114 or the AI system 102 may include operations that the processor 114 or the AI system 102 directs a corresponding system to perform.

The memories 116, 138, 139 may include storage mediums for storing data and instructions. Examples of memory devices that may be used include, but are not limited to random access memory (RAM), persistent or non-volatile storage such as read-only memory (ROM), NAND flash memory, solid state drives (SSDs), hard disk drives (HDDs), optical discs (e.g. CD-ROM, DVD-ROM), or magnetic tapes. The memories 116, 138, 139 may include volatile memory (e.g. RAM) for temporary storage and non-volatile memory (e.g. ROM, flash memory) for persistent storage. The memories 116, 138, 139 may store computer instructions that may be executed by the processor 114, the computing device 104, or the cloud computing device 108 to perform or control performance of one or more of the operations described herein with respect to operation of the AI system 102. In addition, the memories 116, 138, 139 may store the viseme data 126, the input data 128, the output data 130, the sensor data 132, the operation data 142 persistently and/or at least temporarily.

FIGS. 2A and 2B illustrate a front perspective view and a rear perspective view of an example of the AI system 102 of FIG. 1, in accordance with one or more embodiments of the present disclosure.

The AI system 102 may include a housing 248 that houses or contains components of the AI system 102. The housing 248 may at least partially house the processor 114 (not shown in FIGS. 2A and 2B), the memory 116 (not shown in FIGS. 2A and 2B), the sensor 120 (not shown in FIGS. 2A and 2B), the input device 118, or the display 110. In some embodiments, the housing 248 may include an upper body 251 or a handle 250. The upper body 251 may house the display 110.

As shown in FIGS. 2A and 2B, at least a portion of the upper body 251 includes a substantially circular shape. In some embodiments, the upper body 251 is shaped substantially circular, such that the upper body 251 looks substantially the same in various orientations of the AI system 102. Although illustrated as including a circular shape in FIGS. 2A and 2B, the upper body 251 may include any suitable shape. For example, the upper body 251 may include a triangular shape, a diamond shape, a rectangular shape, a square shape, or any other appropriate shape.

In some embodiments, the upper body 251 may define a viewable area 252 of the display 110. Although illustrated as including a circular shape in FIGS. 2A and 2B, the viewable area 252 may include any suitable shape such as an oval. Alternatively, the viewable area 252 may include a non-circular shape. The viewable area 252 may include a portion of the display 110 that is exposed or visible to the user 136. The AI agent 124 may be displayed within the viewable area 252 such that the animated face 254 of the AI agent 124 occupies an entirety of the viewable area 252. In addition, the AI agent 124 may be displayed within the viewable area 252 such that the upper body 251 forms a portion or a boundary of a head of the AI agent 124. As shown in FIG. 2A, the AI agent 124 includes eyes, a mouth, and a face.

The display 110 may display the animated face 254 such that the animated face 254 is substantially centered around a point of the display 110. In some embodiments, the point may include a center axis of the display 110, a center axis of the viewable area 252, or both. In other embodiments, the point may include any point of the display 110. For example, the housing 248 may define the viewable area 252 off center of the display 110 and the point may include the center axis of the viewable area 252.

The processor 114 may control the rotation of the animated face 254 such that the animated face 254 rotates around the point of the display 110. In some embodiments, the processor 114 may cause the animated face 254 to rotate around the point of the display 110 to maintain substantially consistent distances between individual facial features of the animated face 254 and a boundary of the viewable area 252. For example, the processor 114 may cause the animated face 254 to rotate around the point of the display 110 to maintain a substantially consistent distance between the eyes, the mouth, or any other appropriate facial feature of the animated face 254 and the boundary of the viewable area 252 when the AI system 102 is at different orientations. The boundary of the viewable area 252 may be defined by edges of the display 110, the housing 248, or both. In these and other embodiments, the processor 114 may cause the animated face 254 to rotate around the point of the display 110 to maintain a substantially consistent distance between the eyes, the mouth, or any other appropriate facial feature of the animated face 254 and edges of the housing 248 when the AI system 102 is at different orientations. For example, the processor 114 may cause the animated face 254 to rotate around the point of the display 110 to maintain a substantially consistent distance between the eyes, the mouth, or any other appropriate facial feature of the animated face 254 and the edges of the housing 248 when the AI system 102 is at different orientations

In some embodiments, the display 110 may substantially form a front portion or part of a surface of the AI system 102 such that the animated face 254 appears to be embodied by the AI system 102. The display 110 shown in FIG. 2A includes a circular shape. However, the display 110 may include a non-circular shape but the upper body 251 may define the viewable area 252 as including the substantially circular shape. In some embodiments, the animated face 254 of the AI agent 124 may be displayed (e.g., depicted) on the display 110 using a color scheme for the skin tone of the AI agent 124. For example, the animated face 254 of the AI agent 124 may be represented using a single color (e.g., blue).

The input device 118 is shown in FIGS. 2A and 2B as including multiple buttons 144a-c. Each of the buttons 144a-c may correspond to different functions (e.g., push to talk, push to wake, or push to capture image data). Alternatively, two or more of the buttons 144a-c may correspond to the same function. For example, the button 144a-b may both correspond to push to talk. In some embodiments, a back surface 253 of the AI system 102 may include a capacitive touch surface to act as a button or other device to receive the user input.

The button 144c is shown in FIGS. 2A and 2B as being positioned on a rim or an edge of the upper body 251 for easy access. In embodiments with the handle 250, the buttons 144a-b may be located on a front or a back of the handle 250. The exact placement and number of buttons may vary based on the specific form factor and ergonomics of the AI system 102. For example, the handle 250 may be omitted and the input device 118 may only include the button 144c. The buttons 144a-c may include a trigger, an analog stick, a touchpad, a button, a squeeze grip, a D-pad, or some combination thereof.

The upper body 251 may protect the display 110 from being damaged during transport or use of the AI system 102. For example, sides of the display 110 may be covered by the upper body 251 to prevent the sides of the display 110 or other portions of the display 110 from being damaged. Additionally or alternatively, the upper body 251 may be thicker than the display 110 to cause the upper body 251 to contact a ground or other surface more than the display 110 if the AI system 102 is dropped, for example.

In some embodiments, the handle 250 (e.g., lower body) may be used by the user 136 to hold the AI system 102. For example, the user 136 may hold the handle 250 in their hand. In some embodiments, the handle 250 may be shaped in any suitable shape for the user 136 to hold. For example, the handle 250 may include a cylindrical shape. Additionally or alternatively, the upper body 251 may be used by the user 136 to hold the AI system 102.

In some embodiments, the upper body 251 may be connected to the handle 250. In some embodiments, the handle 250 may stem from a side of the upper body 251. The handle 250 may include any suitable shape to act as a handle. For example, the handle 250 may have a cylindrical, cubic, cuboid, and/or any other suitable shape.

In embodiments that include the handle 250, the upper body 251 may include a ring that sits atop the handle 250 to cause the AI system 102 to appear like a magnifying glass. In other embodiments, the handle 250 may be omitted and the AI system 102 may be shaped like a disc. In some embodiments, the AI system 102 may be large enough to be held with two hands, and in other embodiments the AI system 102 may be small enough to be held with one hand.

As shown in FIG. 2B, the camera 122 is positioned on an opposite side as the display 110. Additionally or alternatively, the AI system 102 may include a camera positioned on the same side as the display 110. In some embodiments, the AI system 102 may include multiple cameras positioned on various portions of the AI system 102—e.g., a first camera positioned on the same side as the display 110 and a second camera positioned on a side opposite to the display 110. The AI system 102 may include a power source (not shown). In some embodiments, the power source may be housed in the handle 250.

In some embodiments, the AI system 102 may include a light source 261 configured to assist the camera 122 capture image data. For example, the light source 261 may operate in response to the camera 122 not detecting enough light to properly capture the image data.

As shown in FIG. 2B, the AI system 102 includes two microphones 146a-b to capture audio data. One or more of the microphones 146a-b may be omitted. Additionally or alternatively, more than two microphones 146a-b may be used to capture audio data.

FIGS. 3A and 3B illustrate an example user 136 interacting with the AI system 102 of FIGS. 2A and 2B in different orientations, in accordance with one or more embodiments of the present disclosure. As shown in FIG. 3A, the user 136 is holding the AI system 102 such that the handle 250 extends generally up in the drawing and the handle 250 is in the left hand of the user 136. As shown in FIG. 3B, the user 136 is now holding the AI system 102 such that the handle 250 extends generally to the right and down in the drawing and the handle 250 is in the right hand of the user 136. The user 136 may move the AI system 102 or rotate the AI system 102 (e.g., in a clockwise or counterclockwise direction) to change the orientation of the AI system 102. For example, as shown in FIGS. 3A and 3B, the user 136 switched hands that are holding the handle 250 to rotate and change the orientation of the AI system 102.

Despite the orientation of the AI system 102 changing between FIGS. 3A and 3B (as shown by the handle 250 extending in different directions), the orientation of the animated face 254 of the AI agent 124 is maintained relative to the user 136. For example, the mouth and eyes of the animated face 254 are positioned in both orientations of the AI system 102 so as to have eye contact with the user 136 or to match an orientation of the user 136. Accordingly, regardless of the orientation of the AI system 102, the animated face 254 of the AI agent 124 is displayed on the display 110 such that the AI agent 124 appears in a same orientation as the user 136.

FIG. 4 illustrates a front perspective view of another example of the AI system 102 of FIG. 1, in accordance with one or more embodiments of the present disclosure. The example AI system 102 shown in FIG. 4 includes a smaller form factor than the example of the AI system 102 shown in FIGS. 2A and 2B. For example, the example AI system 102 shown in FIG. 4 includes a smartwatch that can be worn on a wrist of the user 136 or placed in a pocket of the user. Form factor refers to a size, a shape, or a physical design of the AI system 102 and how the AI system 102 fits, interacts, or interfaces with other devices, such as hands of the user 136.

The example AI system 102, as shown in FIG. 4, includes a housing 448. The housing 448 may operate the same as or similar to the upper body 251 discussed above in relation to FIGS. 2A and 2B. For example, the housing 448 may define the viewable area 252 of the display 110. As another example, the housing 448 may house various components of the example AI system 102.

The animated face 254 may be displayed on the display 110 such that the orientation of the animated face 254 is maintained relative to the user as described in more detail below in relation to FIGS. 5A and 5B.

The AI system 102 may be sized to permit smaller hands (e.g., the hands of a child) to interact with the AI system 102 or to permit the AI system 102 to fit on a wrist or in a pocket of the user 136. For example, the AI system 102 may be sized similar to a watch face, a smartphone, a tablet, a laptop, among others. A watch strap (not shown) may be connected to the AI system 102. In some embodiments, the AI system 102 may be placed or connected to a dock 434 to stabilize, charge, or perform any other appropriate operation.

FIGS. 5A and 5B illustrate an example user interacting with the example AI system 102 of FIG. 4, in accordance with one or more embodiments of the present disclosure. FIGS. 5A and 5B illustrate the example AI system 102 in the hands of the user 136 from a perspective of the user 136 (e.g., as if viewed by the user 136). As shown in FIG. 5A, the user 136 is holding the AI system 102 such that band connecting portions 551 extend generally up and to the right in the drawing and the AI system 102 is in the left hand of the user 136. As shown in FIG. 5B, the user 136 is now holding the AI system 102 such that the band connecting portions 551 extend generally up and to the left in the drawing and the AI system 102 is in the right hand of the user 136. The user 136 may move the AI system 102 or rotate the AI system 102 (e.g., in a clockwise or counterclockwise direction) to change the orientation of the AI system 102. For example, as shown in FIGS. 5A and 5B, the user 136 switched hands that are holding the AI system 102 to rotate and change the orientation of the AI system 102.

Despite the orientation of the AI system 102 changing between FIGS. 5A and 5B (as shown by the band connecting portions 551 extending in different directions and the AI system 102 being in different hands of the user 136), the orientation of the animated face 254 of the AI agent 124 is maintained relative to the perspective of the user 136. For example, the mouth and eyes of the animated face 254 are positioned in both orientations of the AI system 102 to have eye contact with the user 136 (e.g., appear to look towards or to match an orientation of the user 136). Accordingly, regardless of the orientation of the AI system 102, the animated face 254 of the AI agent 124 is displayed on the display 110 such that the AI agent 124 appears in a same orientation as the user 136.

FIG. 6 illustrates a block diagram of an example computing system 600 that may be implemented in the environment 100 of FIG. 1, in accordance with one or more embodiments of the present disclosure. In some embodiments, the computing system 600 may be implemented on the AI system 102, the computing device 104, or the cloud computing device 108 of FIG. 1. The computing system 600 may implement or direct one or more suitable operations described in the present disclosure. For example, the computing system 600 may be configured to control the AI system 102 of FIGS. 1-5B, the computing device 104 of FIG. 1, or the cloud computing device 108 of FIG. 1. Additionally, the computing system 600 may obtain and process user input to generate a corresponding output as described in relation to FIG. 1. The computing system 600 may include a processor 602, memory 604, a power source 606, an input interface 608, a display 610, a communication unit 612, and a sensor 616. The processor 602, the memory 604, the power source 606, the input interface 608, the display 610, the communication unit 612, or the sensor 616 may be communicatively coupled.

Generally, the processor 602 may include any suitable special-purpose or general-purpose computer, computing entity, or processing device including various computer hardware or software modules and may be configured to execute instructions stored on any applicable computer-readable storage media. For example, the processor 602 may include a microprocessor, a microcontroller, a parallel processor such as a graphics processing unit (GPU) or tensor processing unit (TPU), a digital signal processor (DSP), an application-specific integrated circuit (ASIC), a Field-Programmable Gate Array (FPGA), or any other digital or analog circuitry configured to interpret and/or to execute program instructions and/or to process data.

Although illustrated as a single processor in FIG. 6, it is understood that the processor 602 may include any number of processors distributed across any number of networks or physical locations that are configured to perform individually or collectively any number of operations described herein. In some embodiments, the processor 602 may interpret and/or execute program instructions and/or process data stored in the memory 604. In some embodiments, the processor 602 may execute the program instructions stored in the memory 604. For example, in some embodiments, the processor 602 may execute program instructions stored in the memory 604 that are related to task execution such that the computing system 600 may perform or direct the performance of the operations associated therewith as directed by the instructions.

The memory 604 may include computer-readable storage media or one or more computer-readable storage mediums for carrying or having computer-executable instructions or data structures stored thereon. Such computer-readable storage media may be any available media that may be accessed by a general-purpose or special-purpose computer, such as the processor 602.

By way of example, and not limitation, such computer-readable storage media may include non-transitory computer-readable storage media including Random Access Memory (RAM), Read-Only Memory (ROM), Electrically Erasable Programmable Read-Only Memory (EEPROM), Compact Disc Read-Only Memory (CD-ROM) or other optical disk storage, magnetic disk storage or other magnetic storage devices, flash memory devices (e.g., solid state memory devices), or any other storage medium which may be used to carry or store particular program code in the form of computer-executable instructions or data structures and which may be accessed by a general-purpose or special-purpose computer. Combinations of the above may also be included within the scope of computer-readable storage media.

Computer-executable instructions may include, for example, instructions and data configured to cause the processor 602 to perform a certain operation or group of operations as described in this disclosure. In these and other embodiments, the term “non-transitory” as explained in the present disclosure should be construed to exclude only those types of transitory media that were found to fall outside the scope of patentable subject matter in the Federal Circuit decision of In re Nuijten, 500 F.3d 1346 (Fed. Cir. 2007). Combinations of the above may also be included within the scope of computer-readable media.

The power source 606 may include one or more energy storage devices for powering components of the computing system 600. For example, the power source 606 may include one or more batteries. In some embodiments, the one or more batteries may be removable, replaceable, and/or rechargeable.

The communication unit 612 may include any component, device, system, or combination thereof that is configured to transmit or receive information over a network. In some embodiments, the communication unit 612 may communicate with other devices at other locations, the same location, or even other components within the same system. For example, the communication unit 612 may include a modem, a network card (wireless or wired), an infrared communication device, a wireless communication device (such as an antenna), and/or chipset (such as a Bluetooth® device, an 802.6 device (e.g., Metropolitan Area Network (MAN)), a WiFi device, a WiMax device, cellular communication facilities, etc.), and/or the like. The communication unit 612 may permit data to be exchanged with a network and/or any other devices or systems described in the present disclosure.

In some embodiments, the display 610 may be configured as one or more displays, like a liquid crystal display (LCD), light emitting diodes (LED), Braille terminal, or other type of display. In some embodiments, the display 610 may include a touch sensitive display. For example, the display 610 may include a display and/or a screen that is resistive (e.g., pressure sensitive), capacitive (e.g., touch sensitive), projected capacitive, or that uses acoustic waves and infrared signals.

The sensor 616 may include one or more devices and/or sensors for inside-out tracking of the computing system 600. In some embodiments, the sensor 616 may be implemented using any suitable number (e.g., 1, 2, 3, 4, 5, 6, 7, 8, 9, 10, 11, 12, etc.) of degrees of freedom. In these and other embodiments, the different types of sensors may vary depending on a number of degrees of freedom. For example, in six degrees of freedom (6DoF) and/or six-axis applications, the sensor 616 may include accelerometers and gyroscopes, while in nine-axis applications, the sensor 616 may include accelerometers, gyroscopes, and magnetometers. In some embodiments, the sensor 616 may determine the orientation of the computing system 600.

The input interface 608 may include one or more control mechanisms to allow the user to send commands and/or requests to the computing system 600. The commands and/or the requests may relate to certain actions. In some embodiments, the one or more control mechanisms may include any suitable input mechanisms. For example, the one or more mechanisms may include triggers, analog sticks, touchpads, buttons, squeeze grips, d-pads, etc. In some embodiments, the input interface 608 may include any other suitable types of input devices. For example, the input interface 608 may include a microphone configured to receive voice input.

In some embodiments, the input interface 608 may include an on-screen interface shown via the display 610. For example, in instances in which the display 610 is touch sensitive, an on-screen interface may be displayed. In these and other embodiments, the user may interact with the computing system 600 via the on-screen interface.

In the present disclosure, the sensor 616 and/or the processor 602 may be implemented using hardware including one or more processors, central processing units (CPUs) graphics processing units (GPUs), data processing units (DPUs), parallel processing units (PPUs), microprocessors (e.g., to perform or control performance of one or more operations), field-programmable gate arrays (FPGA), application-specific integrated circuits (ASICs), accelerators (e.g., deep learning accelerators (DLAs), optical flow accelerators (OFAs)), programmable vision accelerators (including one or more direct memory address (DMA) systems and/or vector processing units (VPUs)), and/or other processor types. In some other instances, the one or more modules may be implemented using a combination of hardware and software. In the present disclosure, operations described as being performed by a respective module may include operations that the respective module may direct a corresponding computing system to perform.

Modifications, additions, or omissions may be made to FIG. 6 without departing from the scope of the present disclosure. For example, the computing system 600 may include more or fewer elements than those illustrated and described in the present disclosure.

The use of the terms “substantially” or “generally” means fundamentally, largely, or mostly and allow for deviations. For example, substantially circular means exactly circular, mostly circular, or largely circular in appearance. As another example, substantially centered means an object is exactly centered or close to centered in appearance.

In accordance with common practice, the various features illustrated in the drawings may not be drawn to scale. The illustrations presented in the present disclosure are not meant to be actual views of any particular apparatus (e.g., device, system, etc.) or method, but are merely idealized representations that are employed to describe various embodiments of the disclosure. Accordingly, the dimensions of the various features may be arbitrarily expanded or reduced for clarity. In addition, some of the drawings may be simplified for clarity. Thus, the drawings may not depict all of the components of a given apparatus (e.g., device) or all operations of a particular method.

Embodiments described in the present disclosure may be implemented using computer-readable media for carrying or having computer-executable instructions or data structures stored thereon. Such computer-readable media may be any available media that may be accessed by a general purpose or special purpose computer. By way of example, and not limitation, such computer-readable media may include non-transitory computer-readable storage media including Random Access Memory (RAM), Read-Only Memory (ROM), Electrically Erasable Programmable Read-Only Memory (EEPROM), Compact Disc Read-Only Memory (CD-ROM) or other optical disk storage, magnetic disk storage or other magnetic storage devices, flash memory devices (e.g., solid state memory devices), or any other storage medium which may be used to carry or store desired program code in the form of computer-executable instructions or data structures and which may be accessed by a general purpose or special purpose computer. Combinations of the above may also be included within the scope of computer-readable media.

Computer-executable instructions may include, for example, instructions and data, which cause a general-purpose computer, special purpose computer, or special purpose processing device (e.g., one or more processors) to perform a certain function or group of functions. Although the subject matter has been described in language specific to structural features and/or methodological acts, it is to be understood that the subject matter defined in the appended claims is not necessarily limited to the specific features or acts described above. Rather, the specific features and acts described above are described as example forms of implementing the claims.

Terms used in the present disclosure and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

All examples and conditional language recited in the present disclosure are intended for pedagogical objects to aid the reader in understanding the present disclosure and the concepts contributed by the inventor to furthering the art, and are to be construed as being without limitation to such specifically recited examples and conditions. Although embodiments of the present disclosure have been described in detail, various changes, substitutions, and alterations could be made hereto without departing from the spirit and scope of the present disclosure.

What is claimed is:

1. A system comprising:
a sensor configured to generate sensor data based on a factor of the system;
a display configured to display an animated face of an artificial intelligence (AI) agent;
a processor coupled to the sensor and the display, the processor configured to:
determine an orientation of the system based on the sensor data;
determine an orientation of a face of a user relative to the system based on the sensor data; and
control rotation of the animated face on the display based on the orientation of the system and the orientation of the face of the user to maintain a consistent orientation of the animated face on the display relative to the face of the user.

2. The system of claim 1, wherein the display is configured to display the animated face of the AI agent such that the animated face occupies an entirety of a viewable area of the display.

3. The system of claim 1 further comprising a housing configured to house the display, wherein:
the housing defines a viewable area of the display; and
the display is configured to display the AI agent such that the animated face occupies an entirety of the viewable area such that the housing forms a portion of a head of the AI agent.

4. The system of claim 1, wherein:
the animated face of the AI agent includes a facial feature;
the system comprises an input device, the input device configured to capture user input and generate input data representative of the user input;
the processor is configured to;
receive the input data;
identify an output of the system based on the input data; and
animate the facial feature of the animated face based on the identified output of the system such that the facial feature is synchronized with the output of the system.

5. The system of claim 4, wherein:
the facial feature comprises at least one of a mouth or a face;
the system further comprises a memory to store viseme data representative of positions of the mouth or the face when speaking various words; and
the processor is configured to:
identify a word included in the output of the system; and
animate the mouth or the face of the AI agent based on the viseme data such that the mouth or the face are synchronized with the word as part of the output of the system.

6. The system of claim 1, wherein:
the system comprises a housing configured to house the display, at least a portion of the housing comprising a substantially circular shape;
the display comprises a viewable area that includes a substantially circular shape;
the display is configured to display the animated face of the AI agent within the viewable area such that the animated face is substantially centered around a point of the display; and
the processor is configured to control the rotation of the animated face such that the animated face rotates around the point of the display to maintain substantially consistent distances between individual facial features of the animated face and a boundary of the viewable area or edges of the housing when the system is at different orientations.

7. The system of claim 1, wherein:
the animated face of the AI agent includes a facial feature;
the processor is configured to:
identify an output of the system;
determine an emotion corresponding to the output of the system; and
animate the facial feature to show the emotion corresponding to the output of the system.

8. The system of claim 1, wherein
the animated face comprises eyes; and
the processor is configured to:
track movement of eyes of the user based on the sensor data; and
control a gaze of the eyes of the animated face based on the movement of the eyes of the user such that the animated face maintains eye contact with the eyes of the user.

9. The system of claim 1, further comprising a microphone configured to capture audio input and generate audio data representative of the audio input, wherein the processor is configured to:
determine the audio input comprises a wake command based on the audio input; and
cause the display to transition from a standby mode to an active mode and cause the animated face of the AI agent to be displayed.

10. The system of claim 1 further comprising a memory configured to store at least one of sensor data, viseme data, output data, or input data.

11. The system of claim 1, wherein the sensor comprises at least one of an accelerometer, an inertial measurement unit (IMU), a magnetometer, a gyroscope, a magnetic compass, a light detection and ranging sensor, or a camera.

12. The system of claim 1, wherein the processor controls the rotation of the animated face on the display to permit the user to position the system in different positions based on a preference of the user rather than factors of the display or the system.

13. A system comprising:
a sensor configured to generate sensor data based on a factor of the system;
a display configured to display an animated face of an artificial intelligence (AI) agent such that the animated face occupies an entirety of a viewable area of the display, the animated face comprising a facial feature;
a housing configured to house the display, the housing defining the viewable area of the display; and
a processor coupled to the sensor and the display, the processor configured to:
determine an orientation of the system based on the sensor data;
determine an orientation of a face of a user relative to the system based on the sensor data;
position the animated face on the display based on the orientation of the system and the orientation of the face of the user to maintain a consistent orientation of the animated face on the display relative to the face of the user;
identify an output of the system; and
animate the facial feature of the animated face based on the identified output of the system such that the facial feature is synchronized with the output of the system.

14. The system of claim 13, wherein:
the facial feature comprises at least one of a mouth or a face;
the system further comprises a memory configured to store viseme data representative of positions of the mouth or the face when speaking various words; and
the processor is configured to:
identify a word included in the output of the system; and
animate the mouth or the face of the AI agent based on the viseme data such that the mouth or the face are synchronized with the word as part of the output of the system.

15. The system of claim 13, wherein the processor is configured to:
determine an emotion corresponding to the output of the system; and
animate the facial feature to show the emotion corresponding to the output of the system.

16. The system of claim 13, wherein
the animated face comprises eyes; and
the processor is configured to:
track movement of eyes of the user based on the sensor data; and
control a gaze of the eyes of the animated face based on the movement of the eyes of the user such that the animated face maintains eye contact with the eyes of the user.

17. The system of claim 13, further comprising a microphone configured to capture audio input and generate audio data representative of the audio input, wherein the processor is configured to:
determine the audio input comprises a wake command based on the audio input; and
cause the display to transition from a standby mode to an active mode and cause the animated face of the AI agent to be displayed.

18. The system of claim 13 further comprising a memory configured to store at least one of sensor data, viseme data, output data, or input data.

19. The system of claim 13, wherein the sensor comprises at least one of an accelerometer, an inertial measurement unit (IMU), a magnetometer, a gyroscope, a magnetic compass, a light detection and ranging sensor, or a camera.

20. The system of claim 13, wherein the processor controls the position of the animated face on the display to permit the user to position the system in different positions based on a preference of the user rather than factors of the display or the system.
